(19) United States
(12) Patent Application Publication
(10) Pub. No.: US 2007/0003477 A1
(43) Pub. Date: Jan. 4, 2007

(54) Purification of a mixture of h<sb>2</sb>/co by catalysis of the impurities

(76) Inventors: Natacha Haik-Beraud, Nogent sur Marne (FR); Serge Moreau, Velizy Villacoublay (FR); Francois Jantet, Amiens (FR); Jean Freysz, Paris (FR); Audrey Moulin, Vincennes (FR)

Correspondence Address: AIR LIQUIDE, 2700 POST OAK BOULEVARD, SUITE 1800, HOUSTON, TX, 77056, US

(21) Appl. No.: 10/559,864

(22) PCT Filed: Jun. 10, 2004
(86) PCT No.: PCT/FR04/01448

§ 371 Date: May 1, 2006

(30) Foreign Application Priority Data
Jun. 11, 2003 (FR) 03/07007

(51) Int. Cl. C01B 3/24

(52) U.S. Cl. 423/650

(57) ABSTRACT

The invention relates to a method for purifying a gaseous flow containing at least hydrogen (H₂), carbon monoxide (CO), a metal carbonyl, and at least one impurity selected from oxygen (O₂) and unsaturated hydrocarbons. According to said method, the gaseous flow is brought into contact with a first catalytic bed (12) comprising at least one catalyst containing copper, in order to convert at least part of the oxygen and/or at least one unsaturated hydrocarbon in the gaseous flow into at least one catalysis product, at a temperature between 100° C. and 200 ° C. and at a pressure of at least 10 bar. Furthermore, said gaseous flow is also brought into contact with a second adsorption bed (9) in order to adsorb at least the carbonyl metal.

The invention relates to a method for purifying gas mixtures mainly containing hydrogen and carbon monoxide, commonly called H₂/CO mixtures, and optionally containing methane (CH₄), which may be polluted by various impurities to be removed, particularly oxygen and/or unsaturated hydrocarbons and/or NOx.

The H₂/CO gas mixtures can be obtained in various ways, particularly:

by steam or CO₂ reforming, by partial oxidation,

by mixed processes, such as the ATR (autothermal reforming) process, which is a combination of steam reforming and partial oxidation, using gases such as methane or ethane, or

by coal gasification or recovered as waste gas downstream of acetylene plants.

The proportion of CO in these H₂/CO mixtures varies, according to the operating conditions, typically between 5 and 50% by volume. Moreover, apart from hydrogen and CO, the compounds CH₄, CO₂ and H₂O are often comprised in the mixture, in variable proportions.

At present, several alternatives are available for upgrading H₂/CO mixtures, that is, particularly by producing:

pure hydrogen, which has many applications,

pure CO, which is used particularly for the synthesis of acetic acid and phosgene, which is a reaction intermediate in the production of polycarbonates, or

oxo-gas, which is a purified H₂/CO mixture enriched with CO (>45% by volume) useable for the synthesis of butanol, for example.

The reactivity of H₂/CO mixtures is well known.

Thus, the Fischer-Tropsch synthesis has been used for many years to obtain hydrocarbons by the following reaction mechanism (I):
(m/2+n)H₂+nCO→CₙHₘ+nH₂O (I)

A variant pertains to the formation of methane, called methanation, as described by G. A. Mills et al, Catalysis Review, vol. 8, No. 2, 1973, p. 159 to 210, reflected by the following reaction (II):
CO+3H₂→CH₄+H₂O (II)

Carbon monoxide can also decompose by the following Boudouard reaction (III):
2CO→C+CO₂ (III)

In general, numerous metals can be used to catalyze the formation of hydrocarbons from CO and H₂. Examples include the following metals: Ru, Ir, Rh, Ni, Co, Os, Pt, Fe, Mo, Pd, or Ag as explained by F. Fischer, H. Tropsch and P. Dilthey, Brennst-Chem, Vol. 6, 1925, p. 265.

The methanol formation reaction is also carried out on numerous metals, including copper:
CO+2H₂→CH₃OH (IV)

Furthermore, it may also be necessary to purify the H₂/CO mixtures for the purposes of their downstream use, by means of specific reactions that can be carried out using specific catalysts for each specific impurity.

The most common impurities to be removed include O₂, NOx and unsaturated hydrocarbons, particularly ethylene.

The H₂/CO mixtures also occasionally contain catalyst poisons, such as mercury (Hg), arsenic (AsH₃), sulfur (H₂S, thiols, thioethers), halogenated compounds (HBr, HCl, organic halides), iron carbonyl Fe(CO)₅ and nickel carbonyl Ni(CO)₄, which should also be removed.

Other catalyst poisons may also be encountered, such as antimony, tin, bismuth, selenium, tellurium and germanium, whose presence depends on the carbon-containing raw material used.

In general, impurities can be removed from a gas by adsorption, by catalysis or by any suitable chemical treatment.

Thus, the impurities H₂O and CO₂ can be removed from a gas stream on adsorbents, such as activated alumina or zeolite, whereas impurities of the O₂ type can be reduced in the form of water and ethylene compounds can by hydrogenated to alkanes.

Similarly, halogenated compounds, mercury or sulfur present in a gas can be removed by adsorption on specific adsorbents, for example, chemically treated activated carbons.

Moreover, certain compounds, such as organic halides for example, can be decomposed to organic compounds and to halogenated inorganic compounds, in order to facilitate their subsequent removal by adsorption, catalysis or another method.

In practice, the order of removal of the pollutants present in a gas is an important factor.

Thus, it is easily understandable that catalyst “poisons” must be removed upstream of the catalyst or catalysts that they are liable to affect.

Similarly, certain products resulting from catalytic reactions must be removed downstream, particularly by adsorption. This applies, for example, to the compounds H₂O and CO₂ produced by catalytic reactions carried out in the presence of O₂, or products issuing from hydrogenolysis reactions on organic halides (HCl, HBr) that must be adsorbed before reaching the hydrogenation catalyst for which they represent a poison.

Similarly, on a zeolite, water must be adsorbed before CO₂, because water is a poison for this adsorbent.

Adsorption and catalysis can also be carried out alternately or simultaneously. For example, ethylene can be converted catalytically to ethane or be adsorbed on a zeolite adsorbent, or both simultaneously.

In short, a recurrent problem arising at the industrial level is to contact the gas to be purified with a series of adsorbent or catalytic products, in a precise order, one such that the poisons of one product are removed upstream thereof, since the reactions taking place upstream can themselves generate other poisons not present in the gas to be treated.

Moreover, the catalytic reactions used to remove the impurities must not cause the reaction of the H₂/CO gas mixture to be purified. The same applies to the adsorbents used, particularly during their regeneration at high temperature.

Thus, ethylene hydrogenation catalysts, which are commonly based on platinum deposited on alumina, lead to a Fischer-Tropsch reaction (reaction (I) above), with the formation of hydrocarbons, particularly ethylene, which may be more concentrated at the reaction outlet than at the inlet, that is, in the gas before reaction.

Similarly, certain oxidation catalysts cause the formation of methanol that must then be removed downstream of the catalyst bed.

In other words, these supplementary reactions have the result of generating additional reaction products, not present in the initial gas to be purified, which must be removed by adsorption downstream, and in addition to the virtually unavoidable pollutants present in the initial gas.

Furthermore, certain adsorbents are disposable after use, that is, without regeneration, whereas others can be regenerated in a TSA (Temperature Swing Adsorption) cycle.

In fact, during the regeneration step of a TSA cycle, the regeneration gas may also itself contain compounds liable to react chemically under the influence of the temperature and catalytic power of the adsorbent (Fischer-Tropsch reaction (I) and Boudouard reaction (III) described above).

However, the removal of certain catalyst poisons is often poorly controlled on an industrial scale, and certain light halogenated compounds are poorly adsorbed on conventional adsorbents, making it necessary to oversize the beds considerably to try to overcome these problems, thereby making the process economically unviable.

In general, the problem arising from the industrial standpoint pertains both to the number and the nature of adsorption and catalysis operations to be performed, but also, and above all, to the choice of the particular routing order of the H₂/CO stream to be purified, in order to produce and recover an H₂/CO stream stripped of most of the impurities it contains, while avoiding undesirable reactions of the H₂ and CO compounds, particularly during the catalysis step or steps serving to remove the impurities present in the H₂/CO mixture or during the adsorbent regeneration step or steps operating according to the TSA principle, while avoiding or minimizing the formation of additional chemical species not present in the initial feed gas.

Accordingly, the primary goal of the invention is to improve the H₂/CO mixture purification methods of the prior art by proposing an efficient method for purifying an H₂/CO mixture of the oxygen and unsaturated hydrocarbon impurities it contains, while avoiding or minimizing the reactions of the Fischer-Tropsch, Boudouard, methanol formation type, etc., so as to avoid or minimize the conversion of H₂ and CO to compounds that are undesirable, harmful or difficult to remove, such as methanol for example, that is, of compounds liable to degrade the adbsorbents or catalysts located downstream or liable to raise subsequent problems during the use of the H₂/CO mixture.

The solution of the invention is accordingly a method for purifying a gas stream containing at least hydrogen (H₂), carbon monoxide (CO), at least one metal carbonyl and at least one impurity selected from oxygen (O₂) and unsaturated hydrocarbons, in which:

(a) the gas stream is contacted with a first catalyst bed (12) comprising at least one catalyst containing copper, in order to convert at least part of the oxygen and/or at least one unsaturated hydrocarbon present in the gas stream to one or more catalysis products, at a temperature of between 100° C. and 200° C. and at a pressure of at least 10 bar, and

(e) said gas stream is contacted with a second adsorption bed (9) to adsorb at least one metal carbonyl.

The operating temperature range of the reactor is very important in the solution of the invention, because it represents a compromise between the satisfactory conversion of the oxygen and the unsaturated hydrocarbon or hydrocarbons present, and the limited formation of by-products, such as methanol and/or hydrocarbons.

The catalysis products are, on the one hand, saturated hydrocarbons, particularly alkanes, and on the other, water and/or CO₂.

Depending on each case, the method of the invention may comprise one or more of the following technical characteristics:

the gas stream contains at least hydrogen (H₂), carbon monoxide (CO) and methane (CH₄);

the temperature is between 120° C. and 180° C.;

the pressure is between 10 and 80 bar, preferably about 20 to 50 bar;

the gas hourly space velocity is between 1000 and 10 000 Sm³/h/m³, preferably between 2000 and 6000 Sm³/h/m³.

the gas stream also contains one or more organosulfur, organonitrogen and/or organochlorine compounds and (b) the gas stream is contacted with a second catalyst bed to convert at least part of the organosulfur, organonitrogen and/or organochlorine compounds to organic compounds and to polar inorganic compounds, and (c) the gas stream is contacted with a third adsorption bed to adsorb at least part of the inorganic compounds produced in step (b). The organosulfur, organonitrogen and/or organochlorine compounds are, for example, compounds of the CH₃Cl, CH₂Cl₂, CCl₄, CHCl₃, CH₃NH₂, CH₃NHCH₃, CH₃SH, CH₃SCH₃ type, etc. Moreover, the saturated organic compounds produced in step (b) are, for example, alkanes, whereas the polar inorganic compounds produced are compounds of the HCl, HBr, H₂S, NH₃ type, etc.;

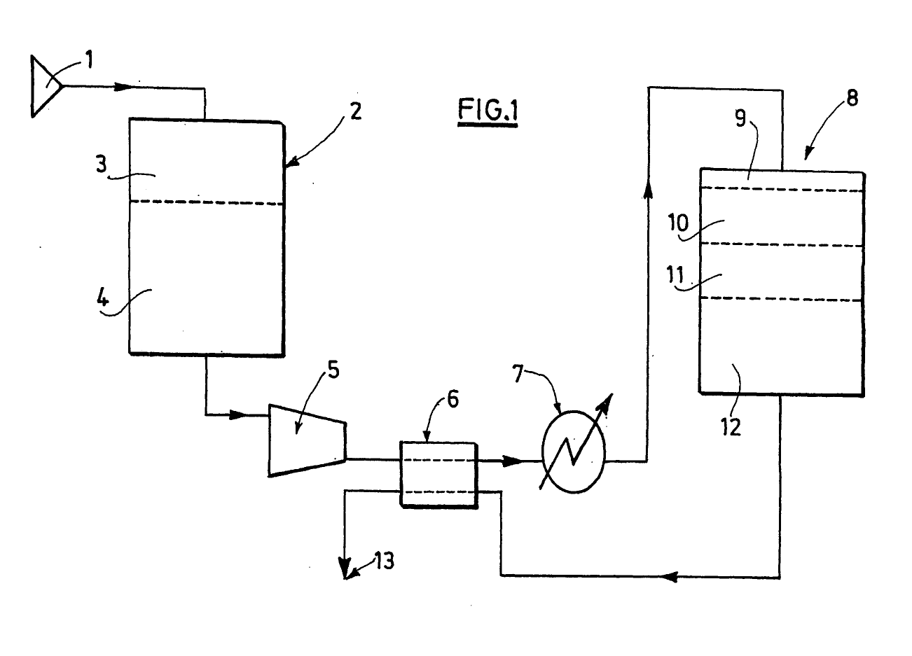

the gas stream also contains HCN impurities and/or at least one compound of an element selected from the group formed by mercury, sulfur, chlorine, arsenic, selenium, bromine and germanium, and (d) said gas stream is contacted with a first adsorption bed to adsorb at least part of the HCN impurities and/or said compound of an element selected from the group formed by mercury, sulfur, chlorine, arsenic, selenium, bromine and germanium. This bed may be the succession of several different products. Preferably, this bed is placed upstream of the catalyst bed or beds 12 and/or the beds 10 and 11 in order to protect it or them (see FIG. 1);

the gas stream also contains at least one metal carbonyl, and (e) said gas stream is contacted with a second adsorption bed to adsorb at least one metal carbonyl, such as carbonyls of iron, nickel, chromium and cobalt, particularly carbonyls of iron, or of nickel;

the gas stream also contains at least one nitrogen oxide (NOx), and (f) said gas stream is contacted with a third catalyst bed to convert at least one nitrogen oxide present in the gas stream, particularly to NH₃ which is retained downstream.

The NOx can be decomposed by several reactions, for example, for N₂O:
N₂O→N₂+½O₂
N₂O+4H₂→2NH₃+H₂O (in the presence of H₂)

Depending on each case, steps (a) and (f) may be distinct, that is, carried out in a dissociated manner using different catalysts, or combined, that is, carried out simultaneously with a single catalyst:

in step (d), the first absorption bed contains at least one material selected from activated carbons, impregnated or not, activated aluminas, impregnated or not, and combinations or mixtures thereof, preferably an activated carbon containing potassium iodide and/or sodium sulfide and/or elemental sulfur;

in step (b), the second catalyst bed contains a copper oxide deposited on a support, preferably the support is a zinc oxide. In certain cases, step (b) can be combined with steps (a) and/or (f);

in step (c), the third adsorption bed contains at least one activated alumina or one activated carbon;

in step (a), the first catalyst bed comprises particles of copper catalyst deposited on a support, preferably a support of the alumina, silica or zinc oxide type;

in step (f), the catalyst bed comprises at least one catalyst selected from catalysts based on copper or a transition metal of the third series, preferably platinum or palladium, deposited on a support;

alternatively, in step (a), a catalyst bed is used to convert at least part of the oxygen present in the gas stream and an additional catalyst bed is used to convert at least one unsaturated hydrocarbon present in the gas stream, said catalyst beds being distinct from one another and placed in any order and able to operate at different temperatures;

it comprises a step during which a gas stream essentially containing hydrogen (H₂) and carbon monoxide (CO), is recovered, the proportion of hydrogen added to the proportion of carbon monoxide in said gas mixture produced being higher than 70% and preferably at least 80% by volume;

the first adsorption bed of step (d) is formed of two adsorption layers each containing at least one adsorbent distinct from that of the other layer;

the gas stream is subjected to at least one compression step during which the heat of compression is used to heat the stream to be purified, thereby reducing the size of the heater located at the catalysis inlet;

the gas stream issuing from one or the other of steps (a) or (f) is contacted with a fourth adsorption bed to remove H₂O and/or CO₂, and/or undergoes a scrubbing step to remove the CO₂ therein, particularly an amine scrubbing step. In fact, the goal of this additional step is to remove the H₂O and/or CO₂ or other compounds that may have been formed by catalysis or which were present in the initial feed gas, for example, methanol, NH₃, hydrocarbons with three or more carbon atoms in their hydrocarbon chain (called “C3+” below). The adsorption bed preferably contains at least one activated alumina or one zeolite. The adsorption steps are carried out according to a TSA cycle with a regeneration temperature lower than or equal to 250° C.;

the catalysts used in the framework of the invention may have identical or different sizes or compositions, for example, sizes between 0.25 and 1 cm;

steps (a) and (f) are distinct or combined. A “distinct” step is different from another “step” insofar as a different type of catalyst and/or a different reaction operating temperature is used, hence a different reactor and/or a different pressure;

the gas stream is subjected to at least one compression step upstream of step (a) and in which all or part of the heat generated by the compression of the stream is used to reach the desired temperature in the reactor or reactors located downstream. A heat input obtained using a heat exchanger serving as a heat recuperator and/or an electric heater may be necessary in certain cases.

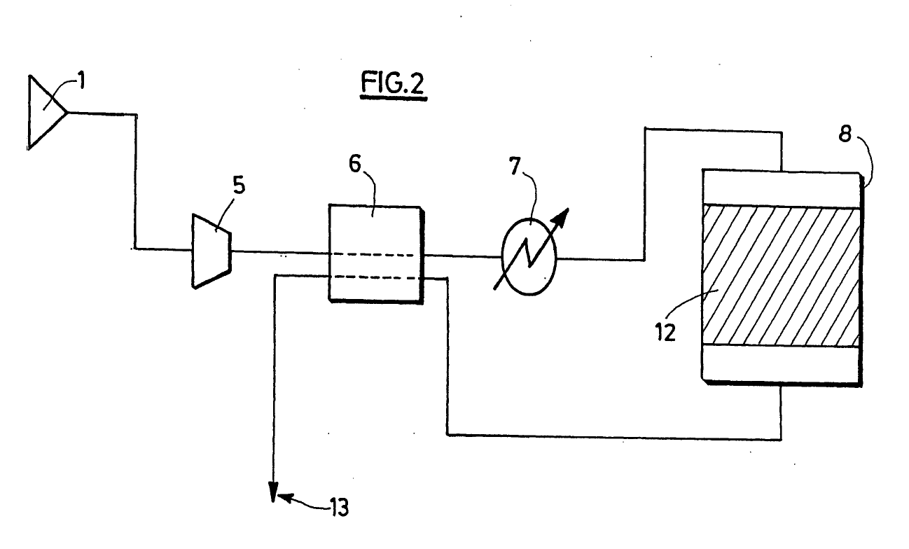

The invention will be better understood from the description below provided with reference to the illustrative FIGS. 1 and 2 appended hereto, which show flowcharts of industrial embodiments of the method of the invention.

In FIG. 1, a gas source 1 feeds a first adsorption reactor 2 with an H₂/CO gas mixture to be purified, said feed being at a pressure of about 20 bar and a temperature of about 35° C.

The gas to be purified passes successively through a first reactor 2 and a second reactor 8 in which it is stripped of all or part of the impurities it contains, particularly the oxygen and/or unsaturated hydrocarbon impurities.

The first adsorption reactor 2 comprises a first adsorption bed formed of two successive adsorption layers 3, 4, that is:

a first adsorption layer 3 containing an adsorbent for removing the HCl and HBr impurities present in the feed gas; and

a second adsorption layer 4 containing an adsorbent for removing the AsH₃, H₂S and Hg impurities present in the feed gas.

The gas prepurified in the first reactor 2 is then sent to a compression unit 5 where it is compressed to a pressure of 47 bar; the compression also causes the gas temperature to rise to about 85° C.

The gas thus compressed (in 5) is subjected to a first heating step using one (or more) heat exchanger(s) 6 in which countercurrent heat exchange takes place with the purified gas, as explained below.

The gas issuing from the heat exchanger 6 is sent to an electric heating unit 7 where it undergoes a second heating step, its temperature being raised or adjusted between 120 and 180° C.

The prepurified gas leaving the electric heater 7 is then sent to a second treatment reactor 8 successively comprising, in the gas stream flow direction, the second adsorption bed 9, the second catalyst bed 10, the third adsorption bed 11 and the first catalyst bed 12 serving to convert at least part of the oxygen and the unsaturated hydrocarbons present in the gas. The bed 9 is placed upstream of the catalyst bed 12 and/or the beds 10 and 11 in order to protect it or them.

Moreover, any NOx present can be removed on a third catalyst bed.

The gas thus purified is then recovered, subjected to heat exchange (in 6) with the prepurified gas compressed in 5, and then sent to a use, storage, or other site 13.

The first adsorption bed 3, 4 is used to retain the easily condensable compounds particularly comprising compounds of mercury, sulfur, chlorine, arsenic, selenium or germanium.

The second adsorption bed 9 is used to adsorb the metal carbonyls, such as Fe(CO)₅ and Ni(CO)₄.

The second catalyst bed 10 is used for converting the organochlorine, organonitrogen and organosulfur compounds to organic compounds and to polar inorganic compounds.

The third adsorption bed 11 is used to adsorb at least the polar inorganic compounds produced by the reaction of the second catalyst bed 10.

The first catalyst bed 12 removes the traces of oxygen and unsaturated hydrocarbons, such as ethylene. The beds 10 and 11 are placed upstream of the catalyst bed 12 in order to protect it. The adsorption bed (11) may be a catalyst bed—optionally the same as the beds 10—which is then deliberately poisoned in certain cases to preserve the bed 12.

Any NOx present is removed on a third catalyst bed.

A fourth adsorption bed may also be provided downstream of the catalyst bed 12, to adsorb at least the products issuing from the second catalyst bed, indeed even a fifth adsorption bed or another treatment, such as an amine scrub or similar, to remove the remaining impurities that have formed during the catalysis reactions or which were initially present in the feed stream but were not stopped up to that point, for example methanol, NH₃ and C₃+ hydrocarbons.

It should be observed that the adsorption beds may comprise a plurality of different specific adsorbents for each specific impurity, which may be mixed together or be arranged in layers.

Similarly, the first catalyst bed may comprise a plurality of different catalysts, for example, a hydrogenation catalyst and an oxidation catalyst, or may comprise a single multipurpose catalyst.

The catalysts used in each of the catalyst beds have an operating temperature of between 100° C. and about 200° C., an operating pressure of between 10 and 80 bar, and are selected so as to cause a minimum of undesirable reactions involving H₂ and CO, such as the Fischer-Tropsch and methanol formation reactions.

The adsorbents downstream of the catalyst bed 12 are used in TSA (Temperature Swing Adsorption) cycles with a regeneration temperature lower than or equal to 250° C., and are also themselves selected so as to cause a minimum of undesirable reactions such as the Fischer-Tropsch, unsaturated compound polymerization reactions and the Boudouard reaction.

The adsorbents used in the framework of the invention for adsorbing various gas compounds are selected for example from:

y-type aluminas having a specific surface area of between 180 and 400 m²/g,

activated carbons having a specific surface area of between 700 and 1300 m²/g,

silica gels having a specific surface area of between 350 and 600 m²/g, and

zeolites having an Si/Al ratio lower than 12 and a pore size higher than 4 Å; cations called compensation cations that may be alkaline or an alkaline earth metal.

Moreover, the catalysts commonly used for gas phase chemical reactions may be formed:

from an “active” metal deposited on a support, such as, for example, α alumina, silica, cordierite, perovskite, hydrotalcite, zinc oxide, titanium dioxide, cerium oxide, manganese oxide or mixtures thereof or defined compounds, or

from an “active” metal precipitated alone or with another compound to form a mixture or a defined compound. Defined compound means a substance comprising a single phase and which can therefore be considered as a pure compound in the physicochemical sense. The “active” metal may be a transition metal (Pt, Pd, Ru, Rh, Mo, Ni, Fe, Cu, Cr, Co, etc.) or a lanthanide (Ce, Y, La, etc).

The catalysts may contain addition elements or compounds having an indirect role in the catalytic process and which facilitate it or increase its stability, selectivity or productivity.

A number of catalysts must be activated on site before use, for example, catalysts containing copper are delivered in oxide form as CuO, and they must be reduced in situ by controlled heating in an atmosphere of hydrogen diluted with an inert gas, such as nitrogen.

Other catalysts can be used as such, such as platinum catalysts.

Similarly, certain adsorbents can be used as such, for example, sulfur-impregnated carbons, whereas others must be regenerated before their first use, such as aluminas or zeolites.

The macroscopic form of the catalyst plays an important rule. In fact, the catalytic reaction comprises three steps:

diffusion of the reactants to the catalytic sites;

chemical reaction on the catalytic sites; and

backdiffusion of the reaction products.

The overall chemical reaction rate also depends on the arrangement of these three mechanism, which depends on the size and shape of the catalyst particles, their porosity, and the state of dispersion of the catalytic sites (surface or core).

Moreover, as the chemical reactions may be accompanied by adsorption or the liberation of heat, it is important to include heat transfers in the choice of catalysts (size, shape, dispersion of active sites in core or on surface), including the support (refractoriness, thermal conductivity).

Embodiments of catalyst and adsorbent beds that can be used to purify an H₂/CO mixture according to the invention are given below.

The first adsorption bed may be comprised upstream of an activated carbon containing potassium iodide to remove compounds of mercury, arsenic and sulfur, followed by a second bed composed of an activated alumina or an activated carbon impregnated with caustic or with sodium carbonate to remove acids, such as H₂S, HCl, HBr, HNO₂, HNO₃, HCN, etc. These types of adsorbents can be obtained from the companies CECA (AC 6% Na₂CO₃, ACF2, SA 1861), NORIT (RBHG 3 and RGM3) or PICA.

Thus, to retain mercury (Hg), activated carbons impregnated with sulfur can be used, references RBHG 4 at Norit, SA 1861 at CECA, SHG at PICA.

To remove H₂S compounds, use can be made of activated carbon with chromium-copper reference RGM3 at Norit, activated carbon with iron from CECA or with copper from PICA, or alumina impregnated with lead oxide from Procatalyse reference MEP 191.

To remove HCl and HBr species, use can be made of activated carbon containing 6% by weight of Na₂CO₃ reference Acticarbone AC40 from CECA, activated carbon containing KOH reference Picatox from PICA, or doped alumina reference SAS 857 from Procatalyse.

To remove AsH₃ compounds, use can be made of activated carbon with chromium-copper available from Norit reference RCM3, or alumina containing lead oxide available from Procatalyse reference MEP 191, or activated carbon with iron marketed by CECA.

To remove HCN, use can be made of the products of Norit (RGM 3, activated carbon with Cu—Cr), CECA (activated carbon with iron), PICA, (Picatox, activated carbon impregnated with Cu—Ag).

As the second adsorbent bed, use can be made of grade A alumina from Procatalyse or an equivalent product from the companies La Roche, ALCOA or ALCAN.

As a second catalyst bed for removing organic chlorides, use can be made of a copper and molybdenum oxide deposited on zinc oxide, for example, catalyst G1 from Süd-Chemie or catalyst Cu 0860T from Engelhard.

As the third adsorption bed, use can be made of an impregnated alumina, such as the product G-92 C from Süd-Chemie, or the product Acticarbone AC40 6% Na₂CO₃ from CECA, or Picatox KOH from PICA.

As the first catalyst bed for removing O₂ and unsaturated hydrocarbons, such as ethylene (C₂H₄), by reducing them to H₂O and ethane (C₂H₆), a copper based catalyst deposited on a support is used such as the product H5451 from Degussa or T-4492 S from Süd-Chemie, the catalysts references Cu-0860, Cu-6300 or Cu-0330 from Engelhard, T4492 from Süd-Chemie, or LK-821-2 from Haldor-Tops\acute{ø}e.

Any NOx present can be removed on a third catalyst bed, for example, the catalysts mentioned above or the catalyst Pd 4586 from Engelhard.

As the fourth and fifth adsorption beds, use can be made of a grade A activated alumina from Procatalyse or an equivalent alumina from the companies La Roche, ALCOA or ALCAN, and a type 13X zeolite from UOP, or 4A, or 5A from UOP. Use can also be made of a single bed consisting of an alumina doped with an alkali metal such as Na₂, or a single mixed bed consisting of a mixture of alumina and zeolite.

In general, the various adsorption beds may be contiguous, that is juxtaposed beds in the method, or may be separated by compression or decompression, heating and/or cooling steps. Additional steps may also be introduced, such as scrubbing by absorption.

The volumes of adsorbents and catalysts are given for guidance, because they depend on the concentration of impurities to be removed and on the properties of the specific products. As a rule, for a given case, it can be considered that the quantity of adsorbent to be used is approximately proportional to the quantity of pollutant to be removed, while the quantity of catalyst is approximately proportional to the contact time or to the inverse of the hourly space velocity (HSV) which is the volume of gas to be treated per hour, related to the volume of catalyst. The volume of gas can be related to the reactor inlet pressure (the HSV then depends on the pressure), or can be expressed in defined conditions, at 1 bar and 0° C. for example (the HSV then does not depend on the pressure); some leeway exists in the choice of the reference conditions to be selected for each application. The contact time and HSV⁻¹ are only approximately proportional, because the contact time, in addition to the pressure, also depends on the temperature along the column, on the variation in the number of moles during the reaction, and on the pressure drops. However, for given reaction conditions, the two parameters can be selected at will.

Another parameter to be taken into account is the content of impurities to be removed at the outlet of the gaseous effluents. On the whole, the lower the desired content, the higher the quantity of adsorbent or catalyst.

Certain steps can be carried out at specific pressures or temperatures. Thus, adsorption is preferably carried out below 80° C., while catalytic reactions take place above 100° C. but below 200° C. to avoid or to minimize undesirable Fischer-Tropsch or similar reactions.

Moreover, the various beds can be placed in several treatment chambers or reactors, so that the gas passing from one to the other is heated or cooled, compressed or expanded, according to the optimal operating conditions of the adsorption or catalysis operations.

As regards adsorption, in certain cases, the adsorbent operates in a cyclic manner, according to the TSA principle, for example, to remove water or alumina or CO₂ on zeolite, and in other cases, the adsorbent is “disposable”, that is, it is replaced by a fresh adsorbent when it reaches saturation.

Certain beds may consist of a single compound, either to carry out two catalytic reactions, such as, for example, to hydrogenate both oxygen and ethylene on palladium catalyst, or to carry out two adsorption operations such as, for example, to adsorb CO₂ and H₂O on a type 13X alumina/zeolite composite, or to carry out an adsorption and catalysis reaction, for example, the decomposition of organochlorines and the adsorption of the resulting HCl, for example, on the Engelhard product reference 0860T.

FIG. 2 shows a simplified flowchart of the method in FIG. 1 of an industrial embodiment in which the gas stream to be treated containing hydrogen, carbon monoxide and at least one impurity selected from oxygen and unsaturated hydrocarbons, is contacted with only one first catalyst bed 12 comprising a copper catalyst, to convert the oxygen and the unsaturated hydrocarbon or hydrocarbons present in the gas stream to one or more catalysis products, at a temperature of between 100° C. and 200° C. and at a pressure of at least 10 bar. The numerals in FIG. 2 denote the same elements as those in FIG. 1.

The examples below illustrate the present invention by proposing several possible arrangements of catalyst and adsorbent beds that can be implemented industrially to treat a gas mixture of the H₂/CO type to be purified containing impurities to be removed.

In all these examples, the initial gas contains about 80% by volume of H₂ and CO, the remainder consisting of methane and impurities to be removed.

Moreover, the configurations given below are considered in the gas flow direction in the receptacle or receptacles containing the various beds or products, that is, the first adsorbent or catalyst is the one located furthest upstream (gas feed to be purified side) and the nth adsorbent or catalyst is the one located furthest downstream (purified gas delivery side).

Furthermore, in these examples, the pressure, flow rate and temperature conditions in the various beds are as follows:

for the reactor 2: 30 000 Sm³/h, 20 barg, 35° C.

for the reactor 8: 30 000 Sm³/h, 47 barg, 120 to 180° C.

where: 1 Sm³=1 m³ at 0° C. and 1 atm, and 1 barg=10⁵ Pa.

### EXAMPLE 1

### H₂/CO Gas Mixture with Various Impurities

In this example, the gas to be purified, in addition to the H₂ and CO compounds to be recovered, contains the following impurities to be removed, that is, arsenic, mercury compounds, metal carbonyls, organic heteroatoms, oxygen, unsaturated hydrocarbons, water, methanol and CO₂.

This gas can be purified by the TSA process using the succession of adsorption and catalyst beds given in Table 1 below.

TABLE 1

| | Adsorbent or | | |
|---|---|---|---|
| Beds | Catalyst | Quantity | Role |
| First | PICATOX CU/AG | 5 m³ | Remove arsenic |
| adsorption (2 | | | compounds in |
| layers) bed | | | particular |
| | PICATOX SHG | 10 m³ | Remove mercury |
| | | | compounds |
| Second | Grade A | 0.8 m³ | Remove metal |
| adsorption | alumina from | | carbonyls of Fe |
| bed | Procatalyse | | and Ni |
| First | Engelhard | 12 m³ | a) Decompose the |
| catalyst bed | copper | | organic |
| | catalyst | | heteroatoms (Cl, |
| | (Cu0860T) | | N, S) by |
| | | | retaining the |
| | | | inorganic |
| | | | compounds |
| | | | produced |
| | | | b) Hydrogenate |
| | | | the oxygen and |
| | | | unsaturated |
| | | | hydrocarbons |
| Third | Grade A | 0.6 m³ | Retain water, |
| adsorption | alumina from | | methanol, NH₃ and |
| bed | Procatalyse | | C3+ hydrocarbons |
| Fourth | Zeolite UOP | 9.5 m³ | Retain CO₂ |
| adsorption | Baylith WE | | |
| bed | G312 | | |

### EXAMPLE 2

### H₂/CO Gas Mixture of Example 1, Additionally Containing a Sulfur Compound (COS)

In this example 2, the composition of the gas to be purified is approximately identical to that of the gas of example 1 but additionally comprises a sulfur product (COS).

This gas can be purified by using the succession of adsorption and catalyst beds given in Table 2 below.

TABLE 2

| | Adsorbent or | | |
|---|---|---|---|
| Beds | Catalyst | Quantity | Role |
| First | PICATOX SHG | 10 m³ | Remove mercury |
| adsorption (2 | | | compounds |
| layers) bed | PICATOX CU/AG | 5 m³ | Remove arsenic |
| | | | compounds in |
| | | | particular |
| Second | Unimpregnated | 0.8 m³ | Retain COS |
| adsorption | activated | | |
| bed | carbon | | |
| Third | Grade A | 0.8 m³ | Remove metal |
| adsorption | alumina from | | carbonyls of Fe |
| bed | Procatalyse | | and Ni |
| First | Engelhard | 12 m³ | a) Decompose the |
| catalyst bed | copper | | organic |
| | catalyst | | heteroatoms (Cl, |
| | (Cu0860T) | | N, S) by |
| | | | retaining the |
| | | | inorganic |
| | | | compounds |
| | | | produced |
| | | | b) Hydrogenate |
| | | | the oxygen and |
| | | | unsaturated |
| | | | hydrocarbons |
| Fourth | Grade A | 0.6 m³ | Retain water, |
| adsorption | alumina from | | methanol, NH₃ and |
| bed | Procatalyse | | C3+ hydrocarbons |
| Fifth | Zeolite UOP | 9.5 m³ | Retain CO₂ |
| adsorption | Baylith WE | | |
| bed | G312 | | |

In this case, the additional presence of COS requires reversing the order of the layers of the first adsorption bed with regard to example 1, and, above all, adding a bed of an unimpregnated activated carbon specifically to remove these sulfur compounds.

### EXAMPLE 3

### H₂/CO Gas Mixture of Example 1 Additionally Containing Nitrogen Oxides

In this example 3, the composition of the gas to be purified is approximately identical to that of the gas in example 1 but additionally comprises nitrogen oxides (NOx).

This gas can be purified by using the succession of adsorption and catalyst beds given in Table 3 below:

TABLE 3

| | Adsorbent or | | |
|---|---|---|---|
| Beds | Catalyst | Quantity | Role |
| First | PICATOX CU/AG | 5 m³ | Remove arsenic |
| adsorption (2 | | | compounds in |
| layers) bed | | | particular |
| | PICATOX SHG | 10 m³ | Remove mercury |
| | | | compounds |
| Second | Grade A | 0.8 m³ | Remove metal |
| adsorption | alumina from | | carbonyls of Fe |
| bed | Procatalyse | | and Ni |
| First | Engelhard | 12 m³ | a) Decompose the |
| catalyst bed | copper | | organic |
| | catalyst | | heteroatoms (Cl, |
| | (Cu0860T) | | N, S) by |
| | | | retaining the |
| | | | inorganic |
| | | | compounds |
| | | | produced |
| | | | b) Hydrogenate |
| | | | the oxygen and |
| | | | unsaturated |
| | | | hydrocarbons |
| Second | Engelhard | 3 m³ | Hydrogenate the |
| catalyst bed | palladium | | nitrogen oxides |
| | catalyst | | |
| Third | Grade A | 0.6 m³ | Retain water, |
| adsorption | alumina from | | methanol, NH₃ and |
| bed | Procatalyse | | C3+ hydrocarbons |
| Fourth | Zeolite UOP | 9.5 m³ | Retain CO₂ |
| adsorption | Baylith WE | | |
| bed | G312 | | |

In this case, the additional presence of NOx requires adding a second catalyst bed specifically to remove these NOx compounds.

### EXAMPLE 4

### H₂/CO Gas Mixture of Example 1 Additionally Containing a Sulfur Compound (COS) and Nitrogen Oxides

In this example 4, the composition of the gas to be purified is approximately identical to that of the gas in example 1 but additionally comprises a sulfur compound (COS) as in example 2 and nitrogen oxides (NOx) as in example 3.

This gas can be purified by using the succession of adsorption and catalyst beds given in Tables 4 and 5 below.

TABLE 4

| | Adsorbent or | | |
|---|---|---|---|
| Beds | Catalyst | Quantity | Role |
| First | PICATOX SHG | 10 m³ | Remove mercury |
| adsorption (2 | | | compounds |
| layers) bed | PICATOX CU/AG | 5 m³ | Remove arsenic |
| | | | compounds in |
| | | | particular |
| Second | Unimpregnated | 0.8 m³ | Retain COS |
| adsorption | activated | | |
| bed | carbon | | |
| Third | Grade A | 0.8 m³ | Remove metal |
| adsorption | alumina from | | carbonyls of Fe |
| bed | Procatalyse | | and Ni |
| First | Engelhard | 12 m³ | a) Decompose the |
| catalyst bed | copper | | organic |
| | catalyst | | heteroatoms (Cl, |
| | (Cu0860T) | | N, S) by |
| | | | retaining the |
| | | | inorganic |
| | | | compounds |
| | | | produced |
| | | | b) Hydrogenate |
| | | | the oxygen and |
| | | | unsaturated |
| | | | hydrocarbons |
| Second | Engelhard | 3 m³ | Hydrogenate the |
| catalyst bed | palladium | | nitrogen oxides |
| | catalyst | | |
| Fourth | Grade A | 0.6 m³ | Retain water, |
| adsorption | alumina from | | methanol, NH₃ and |
| bed | Procatalyse | | C3+ hydrocarbons |
| Fifth | Zeolite UOP | 9.5 m³ | Retain CO₂ |
| adsorption | Baylith WE | | |
| bed | G312 | | |

In this case, the additional presence of COS requires reversing the order of the layers of the first adsorption bed with regard to example 1 and adding a bed of unimpregnated activated carbon, as in example 2, while the presence of NOx requires adding an additional catalyst bed, as in example 3.

However, if more catalysts are to be used, the configuration given in Table 5 below can be employed.

TABLE 5

| | Adsorbent or | | |
|---|---|---|---|
| Beds | Catalyst | Quantity | Role |
| First | PICATOX SHG | 10 m³ | Remove mercury |
| adsorption | | | compounds |
| (2 layers) | PICATOX CU/AG | 5 m³ | Remove arsenic |
| bed | | | compounds in |
| | | | particular |
| Second | Unimpregnated | 0.8 m³ | Retain COS |
| adsorption | activated | | |
| bed | carbon | | |
| Third | Grade A | 1.8 m³ | Remove metal |
| adsorption | alumina from | | carbonyls of Fe |
| bed | Procatalyse | | and Ni |
| First | Süd-Chemie | 6 m³ | Convert |
| catalyst bed | catalyst G1 | | organochlorine |
| | | | compounds to |
| | | | inorganic |
| | | | chlorine |
| Fourth | Süd-Chemie | 4 m³ | Adsorb HCl |
| adsorption | adsorbent | | |
| bed | G-92 C | | |
| Second | Süd-Chemie | 6 m³ | Hydrogenate O₂ |
| catalyst bed | G-133 | | and C₂H₄ |
| Third | Engelhard | 3 m³ | Hydrogenate the |
| catalyst bed | palladium | | nitrogen oxides |
| | catalyst | | |
| Fifth | Grade A | 0.6 m³ | Retain water, |
| adsorption | alumina from | | methanol, NH₃ |
| bed | Procatalyse | | and C3+ |
| | | | hydrocarbons |
| Sixth | Zeolite UOP | 9.5 m³ | Retain CO₂ |
| adsorption | Baylith WE | | |
| bed | G312 | | |

1-12. (canceled)

13. A method for purifying a gas stream containing at least hydrogen (H₂), carbon monoxide (CO), at least one metal carbonyl and at least one impurity selected from oxygen (O₂) and unsaturated hydrocarbons, in which:
(a) the gas stream is contacted with a first catalyst bed comprising at least one catalyst containing copper, in order to convert at least part of the oxygen and/or at least one unsaturated hydrocarbon present in the gas stream to one or more catalysis products, at a temperature of between 100° C. and 200° C. and at a pressure of at least 10 bar; and
(b) said gas stream is contacted with a second adsorption bed to adsorb at least one metal carbonyl.

14. The method of claim 13, wherein the temperature is between 120° C. and 180° C. and/or the pressure is between 10 and 18 bar, preferably about 20 to 50 bar.

15. The method of claim 13, wherein the gas hourly space velocity is between 1000 and 10000 Sm³/h/m³, preferably between 1000 and 6000 Sm³/h/m³.

16. The method of claim 13, wherein the gas stream also contains one or more organosulfur, organonitrogen and/or organochlorine compounds, and in that:
(c) the gas stream is contacted with a second catalyst bed to convert at least part of the organosulfur, organonitrogen and/or organochlorine compounds to organic compounds and to polar inorganic compounds; and
(d) the gas stream is contacted with a third adsorption bed to adsorb at least part of the inorganic compounds produced in step (c).

17. The method of claim 13, wherein the gas stream also contains HCN impurities and/or at least one compound of an element selected from the group formed by mercury, sulfur, chlorine, arsenic, selenium, bromine and germanium, and in that:
(e) said gas stream is contacted with a first adsorption bed to adsorb at least part of the HCN impurities and/or at least one compound of at least one element selected from the group formed by mercury, sulfur, chlorine, arsenic, selenium, bromine and germanium.

18. The method of claim 13, wherein the gas stream also contains at least one nitrogen oxide (NOₓ), and in that:
(f) said gas stream is contacted with a third catalyst bed to convert at least one nitrogen oxide present in the gas stream.

19. The method of claim 18, wherein steps (a) and (f) are distinct.

20. The method of claim 18, wherein steps (a) and (f) are combined.

21. The method of claim 13, wherein in step (a), at least part of the oxygen and/or at least one unsaturated hydrocarbon are converted to catalysis products selected from water vapor (H₂O), carbon dioxide (CO₂) and/or alkanes.

22. The method of claim 13, wherein the gas stream to be separated contains 10% by volume to 90% by volume of H₂, 10% by volume to 90% by volume of CO and, optionally, methane.

23. The method of claim 18, wherein the gas stream issuing from one or the other of steps (a) or (f) is contacted with a fourth adsorption bed to remove H₂O and/or CO₂ and/or optionally CH₃OH and/or hydrocarbons formed during the passages over the catalyst beds, and/or a scrubbing step to remove the CO₂ and/or the methanol therein, particularly an amine scrub.

24. The method of claim 13, wherein the gas stream is subjected to at least one compression step upstream of step (a) and in which all or part of the heat generated by the compression of the stream is used to reach the desired temperature.
